(19) United States
(12) Patent Application Publication
(10) Pub. No.: US 2026/0113520 A1
(43) Pub. Date: Apr. 23, 2026

(54) CAMERA MODULE

(71) Applicant: SAMSUNG ELECTRO-MECHANICS CO., LTD., Suwon-si (KR)

(72) Inventors: Yunjeong HWANG, Suwon-si (KR); Gye-Won LEE, Suwon-si (KR); Jongwoon KIM, Suwon-si (KR); Seung Hun RYU, Suwon-si (KR); Won SEO, Suwon-si (KR); Joonhyung LIM, Suwon-si (KR); Hwahyun JEON, Suwon-si (KR)

(73) Assignee: SAMSUNG ELECTRO-MECHANICS CO., LTD., Suwon-si (KR)

(21) Appl. No.: 19/290,680

(22) Filed: Aug. 5, 2025

(30) Foreign Application Priority Data
Oct. 22, 2024 (KR) 10-2024-0145067
Mar. 6, 2025 (KR) 10-2025-0029268

(51) Int. Cl. H04N 23/51; H04N 23/54; H04N 23/55; H04N 23/56

(52) U.S. Cl. CPC H04N 23/51; H04N 23/54; H04N 23/55; H04N 23/56

(57) ABSTRACT

A camera module includes an upper housing accommodating a lens module; and a lower housing, coupled to the upper housing, configured to support a circuit board, the lower housing comprising a chassis coupled to a lower portion of the circuit board and a shield cover coupled to a lower portion of the chassis. The chassis has an opening extending through a surface of the chassis to expose a portion of one surface of the circuit board.

### CROSS-REFERENCE TO RELATED APPLICATIONS

This application claims the benefit under 35 USC 119(a) of Korean Patent Application Nos. 10-2024-0145067 filed on Oct. 22, 2024, and 10-2025-0029268 filed on Mar. 6, 2025, with the Korean Intellectual Property Office, the entire disclosures of which are incorporated herein by reference for all purposes.

### BACKGROUND

### 1. Field

The present disclosure relates to a camera module.

### 2. Description of the Background

Due to the remarkable development of information and communication technology, semiconductor technology, and the like, cameras may be used in moving mechanical devices such as an autonomous vehicle and an industrial robot.

A camera module installed in a vehicle may be used in various positions, such as the front, side, rear, and interior room mirror of the vehicle. While a camera in an industrial robot may be disposed at the front of a face, the side of the face, the rear of the face, a palm, the back of a hand, a wrist, or the front of a knee of the industrial robot.

Because the camera module for the vehicle and the camera for the industrial robot are used in a confined space or a harsh external environment, thermal dissipation inside the camera module may be an issue.

A method in which a heat dissipation member is attached to a bottom surface of a circuit board on which an image sensor is mounted to form a path for heat dissipation through the housing may be used in a camera module for a vehicle and industrial robot. However, a housing mostly made of aluminum may cause the height of the camera module to increase, which may cause a problem in which the heat dissipation efficiency is reduced due to the thick aluminum housing.

Therefore, it may be desirable to develop a structure capable of minimizing an increase in the size of the module while efficiently dissipating heat inside the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes an upper housing accommodating a lens module; and a lower housing coupled to the upper housing, and configured to support a circuit board, the lower housing comprising a chassis coupled to a lower portion of the circuit board and a shield cover coupled to a lower portion of the chassis. The chassis has an opening extending through a surface of the chassis to expose a portion of one surface of the circuit board.

The shield cover may include a protruding portion corresponding to the opening.

The opening may correspond to an electronic component disposed on the circuit board.

The electronic component may include an image sensor, a serializer/deserializer, and a power management integrated circuit. The opening may include a first opening corresponding to the image sensor, a second opening corresponding to the serializer/deserializer, and a third opening corresponding to the power management integrated circuit.

The protruding portion may include a first protruding portion corresponding to the first opening, a second protruding portion corresponding to the second opening, and a third protruding portion corresponding to the third opening.

The camera module may further include a first heat dissipation member disposed between the electronic component and the protruding portion to dissipate heat generated from the electronic component.

The chassis may be a plate-shaped member with bent edges configured to support the circuit board.

The chassis may include a plate-shaped portion facing the one surface of the circuit board and a side plate portion bent along the edges of the plate-shaped portion to support the circuit board.

The opening may be in the plate-shaped portion.

The shield cover may include a bottom portion and a wall portion bent along edges of the bottom portion to accommodate the chassis.

A protruding portion at the bottom portion may correspond to an electronic component disposed on the circuit board.

The chassis may include at least one protrusion on an outer side surface thereof, and the shield cover may include at least one hole coupled to the protrusion on an inner side surface thereof.

The camera module may further include a light emitting diode module disposed around the lens module and connected to the circuit board.

The light emitting diode module may include a light emitting diode chip and a light emitting diode substrate. The camera module may further include a second heat dissipation member disposed between the light emitting diode substrate and the upper housing to dissipate heat generated from the light emitting diode module.

The chassis may be stainless steel.

The shield cover may be stainless steel.

Other features and aspects will be apparent from the following detailed description, the drawings, and the claims.

### BRIEF DESCRIPTION OF THE DRAWINGS

FIG. 1 is a perspective view illustrating an appearance of a camera module according to an embodiment.

FIG. 2 is an exploded perspective view schematically illustrating the camera module according to an embodiment.

FIG. 3 is a perspective view illustrating a portion of the camera module according to an embodiment.

FIG. 4 is an exploded perspective view schematically illustrating a portion of the camera module according to an embodiment.

FIG. 5 is a perspective view illustrating a chassis of the camera module according to an embodiment.

FIG. 6 is a perspective view illustrating a lower housing of the camera module according to an embodiment.

FIG. 7 is a cross-sectional view taken along a line V-V′ of FIG. 1.

FIG. 8 is a view showing a heat dissipation path of the camera module according to an embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

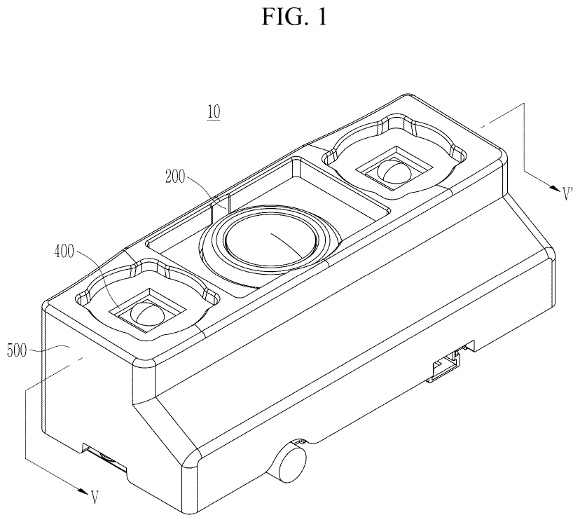

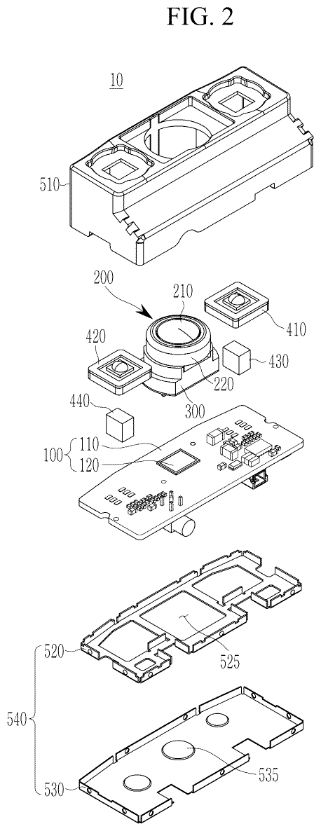

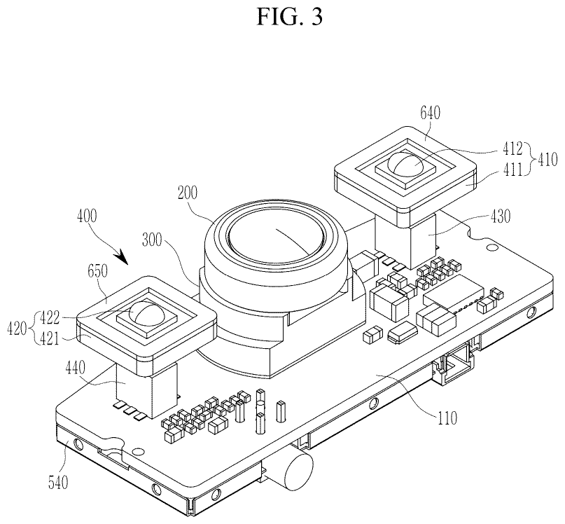

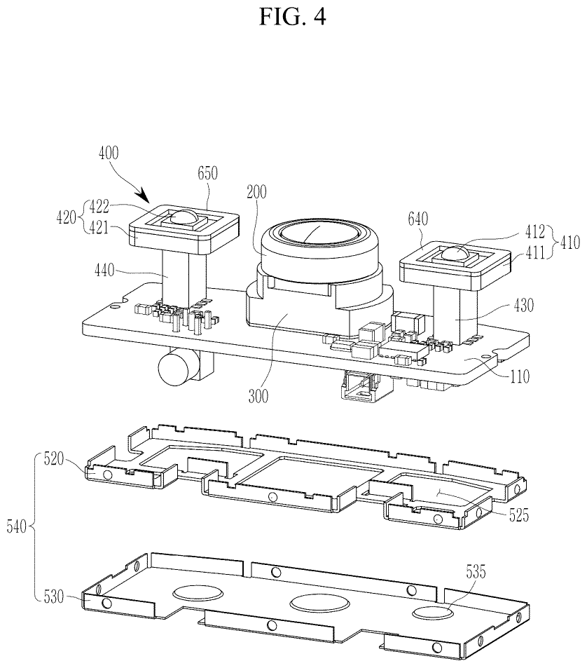

FIG. 1 is a perspective view illustrating an appearance of a camera module according to an embodiment. FIG. 2 is an exploded perspective view schematically illustrating the camera module according to an embodiment. FIG. 3 is a perspective view illustrating a portion of the camera module according to an embodiment. FIG. 4 is an exploded perspective view schematically illustrating a portion of the camera module according to an embodiment.

Referring to FIGS. 1 to 4, a camera module 10 according to an embodiment may include an image sensor module 100, a lens module 200, a lens driving module 300, a light emitting diode (LED) module 400, and a housing assembly 500.

The image sensor module 100 may include a circuit board 110 and an image sensor 120. The circuit board 110 may be electrically connected to a main board (not shown), and may include a circuit board with a wiring pattern capable of being electrically connected, such as a rigid circuit board, a flexible circuit board, or a rigid flexible circuit board.

The image sensor 120 may be a device that converts light incident through a lens of the lens module 200 into an electrical signal, and may be any one of a charge-coupled device (CCD) and a complementary metal oxide semiconductor (CMOS), but the present disclosure is not limited thereto.

The image sensor 120 may be mounted on one surface of the circuit board 110, and may be disposed below the lens module 200 along an optical axis direction of the lens. The image sensor 120 and the circuit board 110 may be connected by a method such as wire bonding. The electrical signal converted by the image sensor 120 may be output as an image through a display unit (or a display portion) of an electronic device.

The lens module 200 may include at least one lens 210 and a lens barrel 220 that accommodates the lens 210. The lens 210 may include one or more lenses having optical characteristics such as the same or different refractive indices, and may be installed at the lens barrel 220 along an optical axis. The optical axis may be set as a central axis of the lens accommodated in the lens barrel 220, and a direction of the optical axis may mean a direction parallel to the central axis. The lens 210 may be disposed in as many numbers as desired based on the design of the lens barrel 220.

The lens barrel 220 may have a hollow cylindrical shape so that at least one lens 210 photographing a subject may be accommodated therein. The image sensor 120 may be disposed below the lens barrel 220 along the direction of the optical axis to convert light incident through the lens barrel 220 into an electrical signal. The electrical signal may be transferred to the circuit board 110 and may be transmitted to an electronic device such as a mobile phone.

The lens driving module 300 may be a device that moves the lens module 200, and may include a lens actuator (not shown) and an actuator housing 310.

The lens actuator may include an AF driving unit (or an AF driving portion) and an OIS driving unit (or an OIS driving portion), and may move the lens barrel 220 to adjust focus or correct shaking. For example, the AF driving unit may include an AF driving magnet and an AF driving coil, and may implement a function of adjusting focus or a zoom function by moving the lens barrel 220 along the optical axis by electromagnetic influence between the AF driving magnet and the AF driving coil. In addition, the OIS driving unit may include an OIS driving magnet and an OIS driving coil, and may implement a function of correcting hand shaking or shaking by moving the lens barrel 220 in a direction perpendicular to the optical axis by electromagnetic influence between the OIS driving magnet and the OIS driving coil.

The actuator housing 310 may accommodate a lens actuator and the lens barrel 220 in an internal space thereof, and may be disposed on the circuit board 110. The lens barrel 220 may move in the direction of the optical axis or the direction perpendicular to the optical axis in a state in which the lens barrel 220 is accommodated in the actuator housing 310 by a driving force of the lens actuator.

The actuator housing 310 may have an opening extending through a surface of the actuator housing 310 for accommodating the lens barrel 220 formed at an upper portion thereof, and may have an open lower portion so that the image sensor 120 is disposed at a lower portion thereof. Accordingly, the actuator housing 310 may include an upper surface having an opening formed therein for accommodating the lens barrel 220 and a side surface extending downward from the upper surface.

The LED module 400 may act as lighting at night to obtain a clear image even at night. The LED module 400 may be disposed around the lens module 200, and may include a first LED module 410 and a second LED module 420, each disposed on left and right sides.

The first LED module 410 may include a first LED substrate 411 and a first LED chip 412, and the second LED module 420 may include a second LED substrate 421 and a second LED chip 422. The first LED module 410 and the second LED module 420 may be connected to the circuit board 110 through a first post 430 and a second post 440 in which electrode terminals are respectively embedded.

The housing assembly 500, potentially made of a metal plate, may protect an internal component of the camera module 10, and may be formed of a material with a low corrosion rate, such as stainless steel (SUS). Additionally, the housing assembly 500 may function to shield an electromagnetic wave. For example, the housing assembly 500 may shield the electromagnetic wave to prevent an electromagnetic wave generated inside the camera module 10 from affecting another electronic component within an electronic device or to prevent a noise current flowing from outside the camera module 10 from affecting the inside of the camera module 10.

The housing assembly 500 may include an upper housing 510 that accommodates the lens module 200 and a lower housing 540 that is coupled to the upper housing 510 and supports the circuit board 110. The upper housing 510 and the lower housing 540 may be coupled to each other to form an internal space of the camera module 10.

Electronic components such as a serializer/deserializer (SerDes) 150 for high-speed data transmission and a power management integrated circuit (PMIC) 170 for generating, distributing, and controlling electric power desired for each component within the camera module 10 may be disposed in an internal space formed by the housing assembly 500. The serializer/deserializer 150 and the power management integrated circuit 170 may be disposed on one surface of the circuit board 110. For example, the serializer/deserializer 150 and the power management integrated circuit 170 may be disposed on a back surface of the installation surface of the image sensor 120.

The lower housing 540 may include a chassis 520 coupled to a lower portion of the circuit board 110 and a shield cover 530 coupled to a lower portion of the chassis 520. Both the chassis 520 and the shield cover 530 may be manufactured by bending a plate-shaped member of stainless steel (SUS), and may be manufactured with a thickness of 0.15 to 0.3 mm so that the chassis 520 and the shield cover 530 may be miniaturize compared with a conventional aluminum cover and may be advantageous in dissipating heat.

The chassis 520 may be formed by bending an edge of the plate-shaped member to support the circuit board 110, and the shield cover 530 may be formed by bending an edge of the plate-shaped member to accommodate the chassis 520.

The chassis 520 may have at least one opening 525 extending through a surface of the chassis 520 to expose at least a portion of one surface of the circuit board 110, and the shield cover 530 may include at least one protruding portion 535 corresponding to the opening 525.

To dissipate heat from electronic components disposed inside the camera module 10, a heat dissipation member 600 may be disposed around each electronic component. The heat dissipation member 600 may be made of a thermal interface material (TIM), and may be manufactured by mixing a polymer resin with a thermally conductive filler such as ceramic. The resin may be silicon or acrylic, and the thermally conductive filler may be ceramics such as aluminum oxide (Al₂O₃), boron nitride (BN), and graphite, polymers such as PP and PTFE, or metals such as silver and copper. The heat dissipation member 600 may be a heat dissipation pad, a heat dissipation grease, a heat dissipation adhesive, a heat dissipation tape, a phase change material (PCM), or the like.

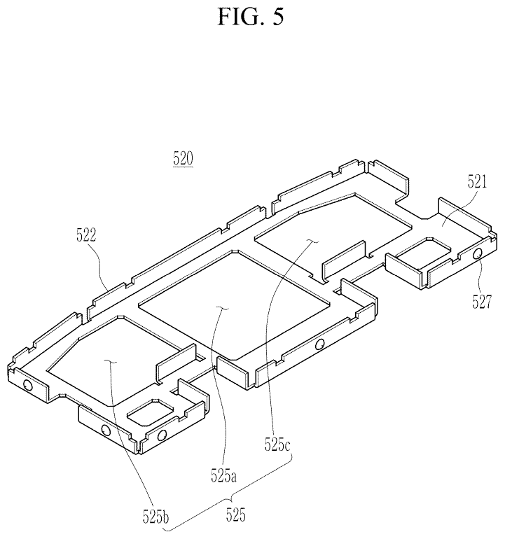

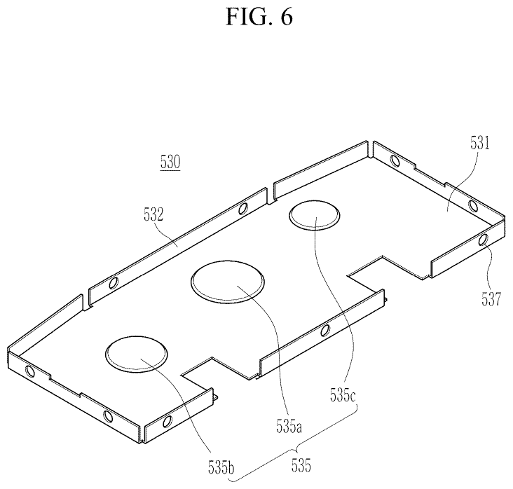

Hereinafter, the chassis 520 and the shield cover 530 of the camera module 10 according to the present embodiment will be described in more detail with reference to FIG. 5 and FIG. 6. FIG. 5 is a perspective view illustrating the chassis of the camera module according to an embodiment, and FIG. 6 is a perspective view illustrating the lower housing of the camera module according to an embodiment.

Referring to FIG. 5, the chassis 520 may include a plate-shaped portion 521 facing one surface of the circuit board 110 and a side plate portion 522 bent along an edge of the plate-shaped portion 521 to support the circuit board 110.

The opening 525 may be formed at the plate-shaped portion 521 to correspond to at least one of the electronic components installed at the circuit board 110. The opening 525 may check the installation state of the electronic component installed at the circuit board 110, and may expose the electronic component to the application of the heat dissipation member 600. That is, the opening 525 may be formed corresponding to the electronic component so as to expose the electronic component in a state in which the chassis 520 is coupled to the lower portion of the circuit board 110. The electronic component may include the image sensor 120, the serializer/deserializer 150, the power management integrated circuit 170, or the like.

The opening 525 may include a first opening 525a formed corresponding to the image sensor 120, a second opening 525b formed corresponding to the serializer/deserializer 150, and a third opening 525c formed corresponding to the power management integrated circuit 170. The opening 525 may be formed corresponding to a component requiring heat dissipation among electronic components installed at the circuit board 110, and the number and sizes of openings 525 are not limited.

The first opening 525a may be formed to expose a back surface of the circuit board 110 at which the image sensor 120 is installed, the second opening 525b may be formed to expose a portion of the circuit board 110 at which the serializer/deserializer 150 is installed, and the third opening 525c may be formed to expose a portion of the circuit board 110 at which the power management integrated circuit 170 is installed.

The chassis 520 may include at least one protrusion 527 on an outer side surface thereof. The protrusion 527 may couple the chassis 520 to the shield cover 530, and may be formed on the side plate portion 522.

Referring to FIG. 6, the shield cover 530 may accommodate the chassis 520 and, like the chassis 520, the shield cover 530 may be manufactured by bending a plate-shaped member.

The shield cover 530 may include a bottom portion 531 in contact with the plate-shaped portion 521 of the chassis 520, and a wall portion 532 formed by bending along an edge of the bottom portion 531. The shield cover 530 may be coupled to the chassis 520 to function as a shield for an electromagnetic wave.

At least one protruding portion 535 may be formed at the bottom portion 531 to correspond to a position of an electronic component installed at the circuit board 110. That is, the protruding portion 535 may be formed corresponding to a position of the circuit board 110 at which the image sensor 120, the serializer/deserializer 150, and the power management integrated circuit 170 are installed.

The protruding portion 535 may be formed corresponding to the opening 525 of the chassis 520, and may face the electronic component installed at the circuit board 110 through the opening 525. That is, the protruding portion 535 may include a first protruding portion 535a formed corresponding to the first opening 525a, a second protruding portion 535b formed corresponding to the second opening 525b, and a third protruding portion 535c formed corresponding to the third opening 525c. The protruding portion 535 may be formed corresponding to a component requiring heat dissipation among electronic components installed at the circuit board 110, and the number and sizes of protruding portions 535 are not limited.

The first protruding portion 535a may be formed to face a portion of the circuit board 110 at which the image sensor 120 is installed, the second protruding portion 535b may be formed to face a portion of the circuit board 110 at which the serializer/deserializer 150 is installed, and the third protruding portion 535c may be formed to face a portion of the circuit board 110 at which the power management integrated circuit 170 is installed.

The shield cover 530 may include at least one hole 537 on an inner side surface thereof. The hole 537 may be coupled to the protrusion 527 of the chassis 520 to couple the chassis 520 and the shield cover 530, and may be formed at the wall portion 532. The present disclosure is not limited thereto, and the hole may be formed at the chassis, the protrusion may be formed at the chassis, and other means (e.g., another device) for coupling the chassis and the shield cover may be used.

In an assembly process of the lower housing 540, if the chassis 520 is coupled to the circuit board 110 by soldering or the like and then the protrusion 527 is fastened to the hole 537 of the shield cover 530, the chassis 520 and the shield cover 530 may be coupled to complete assembly of the lower housing 540.

A structure of the lower housing 540 may shorten an assembly time by assembling the chassis 520 to the circuit board 110 and then checking an installation state of the electronic component through the opening 525 and applying the heat dissipation member 600 and then coupling the shield cover 530 to the chassis 520 to complete the assembly of the lower housing 540. In addition, because a space for applying the heat dissipation member 600 is provided through the opening 525, an increase in a height of the camera module 10 may be minimized.

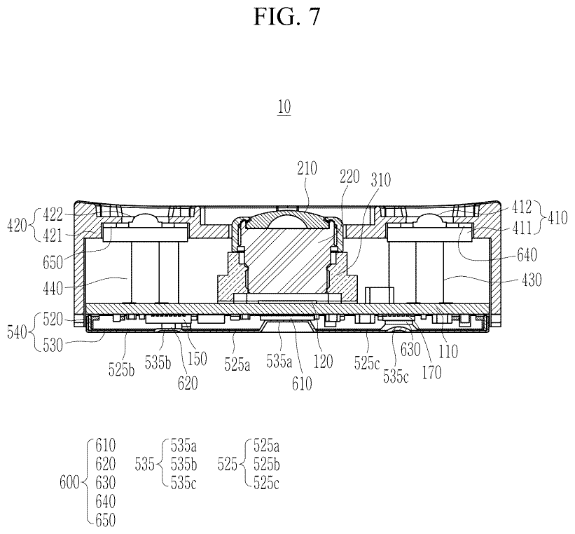

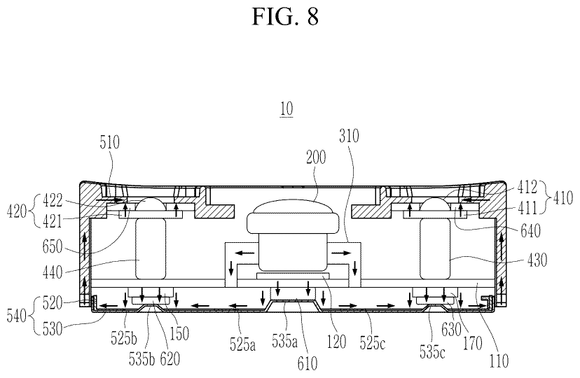

Hereinafter, a heat dissipation structure and a heat dissipation path of the camera module 10 according to the present embodiment will be described in more detail with reference to FIG. 7 and FIG. 8. FIG. 7 is a cross-sectional view taken along a line V-V′ of FIG. 1, and FIG. 8 is a view showing the heat dissipation path of the camera module according to an embodiment.

Referring to FIG. 7, the heat dissipation member 600 may be disposed between an electronic component and the housing assembly 500 to dissipate heat generated from the electronic component within the camera module 10.

The heat dissipation member 600 may act as a path for transferring heat between a heat-generating component and a heat dissipation plate disposed inside the camera module 10. A main electronic component that emits heat may include the image sensor 120, the serializer/deserializer 150, the power management integrated circuit 170, the LED module 400, or the like, and the heat dissipation plate may be the housing assembly 500. That is, the heat dissipation member 600 may transfer heat generated from the image sensor 120, the serializer/deserializer 150, the power management integrated circuit 170, the LED module 400, or the like to the housing assembly 500 to discharge the transferred heat to the outside of the camera module 10.

To this end, the heat dissipation member 600 may be in contact with the housing assembly 500. For example, a heat dissipation member disposed at the image sensor 120, the serializer/deserializer 150, and the power management integrated circuit 170 may be in contact with the lower housing 540 or the shield cover 530. In this case, the protruding portion 535 formed at the bottom portion 531 of the shield cover 530 may ensure that the heat dissipation member 600 makes firm contact between the electronic component and the shield cover 530. A heat dissipation member disposed at the LED module 400 may be in contact with the upper housing 510.

The heat dissipation member 600 may be disposed between the upper housing 510 and the LED module 400, and may be disposed between the lower housing 540 and the image sensor 120, the serializer/deserializer 150, and the power management integrated circuit 170 installed at the circuit board 110. In the lower housing 540, the heat dissipation member 600 may be disposed at the protruding portion 535 of the shield cover 530.

The heat dissipation member 600 may include a first heat dissipation material 610 disposed between the back surface of the installation surface of the image sensor 120 of the circuit board 110 and the first protruding portion 535a, a second heat dissipation material 620 disposed between the serializer/deserializer 150 and the second protruding portion 535b, and a third heat dissipation material 630 disposed between the power management integrated circuit 170 and the third protruding portion 535c.

The heat dissipation member 600 may include a fourth heat dissipation member 640 disposed between the first LED substrate 411 at which the first LED chip 412 is installed and the upper housing 510, and a fifth heat dissipation member 650 disposed between the second LED substrate 421 at which the second LED chip 422 is installed and the upper housing 510. The heat dissipation member 600 may be disposed to correspond to a heat-generating electronic component installed at the circuit board 110. The number or positions of heat dissipation members 600 are not limited thereto.

Referring to FIG. 8, in the heat dissipation path of the camera module 10 according to the present embodiment, heat generated from the image sensor 120 may be transferred to the shield cover 530 through the first heat dissipation material 610, and may be transferred to the upper housing 510 coupled to the shield cover 530 to be discharged to the outside of the camera module 10.

Additionally, heat generated from the serializer/deserializer 150 may be transferred to the shield cover 530 through the second heat dissipation material 620, and heat generated from the power management integrated circuit 170 may be transferred to the shield cover 530 through the third heat dissipation material 630. Heat transferred to the shield cover 530 may be transferred to the upper housing 510 to be discharged to the outside of the camera module 10.

Heat generated from the LED module 400 may be transferred to the upper housing 510 through the fourth heat dissipating material 640 and the fifth heat dissipating material 650 to be emitted to the outside of the camera module 10.

According to the present embodiment, heat generated from the electronic component disposed inside the camera module 10 may be discharged to the outside through the upper housing 510 as well as the lower housing 540, so that an efficient heat dissipation path is formed. Recently, a high-pixel image sensor has been adopted due to the high performance of a camera module, and various IC components such as a PMIC, a SerDes, an MCU, and an LED module have been embedded in the camera module. Thus, an error due to heat dissipation within the camera module in the image sensor is becoming a problem, and the present embodiment may maximize the heat dissipation effect of the camera module by forming an efficient heat dissipation path.

One aspect of the embodiments of the present disclosure is intended to provide a camera module capable of minimizing an increase in size thereof while forming an optimized heat dissipation path.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
an upper housing accommodating a lens module; and
a lower housing, coupled to the upper housing, configured to support a circuit board, the lower housing comprising a chassis coupled to a lower portion of the circuit board and a shield cover coupled to a lower portion of the chassis,
wherein the chassis has an opening extending through a surface of the chassis to expose a portion of one surface of the circuit board.

2. The camera module of claim 1, wherein the shield cover comprises a protruding portion corresponding to the opening.

3. The camera module of claim 2, wherein the opening corresponds to an electronic component disposed on the circuit board so that the chassis exposes the electronic component.

4. The camera module of claim 3, wherein the electronic component comprises an image sensor, a serializer/deserializer, and a power management integrated circuit, and the opening comprises a first opening corresponding to the image sensor, a second opening corresponding to the serializer/deserializer, and a third opening corresponding to the power management integrated circuit.

5. The camera module of claim 4, wherein the protruding portion comprises a first protruding portion corresponding to the first opening, a second protruding portion corresponding to the second opening, and a third protruding portion corresponding to the third opening.

6. The camera module of claim 3, further comprising a first heat dissipation member disposed between the electronic component and the protruding portion to dissipate heat generated from the electronic component.

7. The camera module of claim 1, wherein the chassis is a plate-shaped member with bent edges configured to support the circuit board.

8. The camera module of claim 7, wherein the chassis comprises a plate-shaped portion facing the one surface of the circuit board and a side plate portion bent along the edges of the plate-shaped portion to support the circuit board.

9. The camera module of claim 8, wherein the opening is in the plate-shaped portion.

10. The camera module of claim 1, wherein the shield cover comprises a bottom portion and a wall portion bent along edges of the bottom portion to accommodate the chassis.

11. The camera module of claim 10, wherein a protruding portion at the bottom portion corresponds to an electronic component disposed on the circuit board.

12. The camera module of claim 1, wherein the chassis comprises at least one protrusion on an outer side surface thereof, and the shield cover comprises at least one hole coupled to the protrusion on an inner side surface thereof.

13. The camera module of claim 1, further comprising a light emitting diode module disposed around the lens module and connected to the circuit board.

14. The camera module of claim 13, wherein the light emitting diode module comprises a light emitting diode chip and a light emitting diode substrate, and the camera module further comprises a second heat dissipation member disposed between the light emitting diode substrate and the upper housing to dissipate heat generated from the light emitting diode module.

15. The camera module of claim 1, wherein the chassis is stainless steel.

16. The camera module of claim 1, wherein the shield cover is stainless steel.
